(19) United States
(12) Patent Application Publication
(10) Pub. No.: US 2003/0002064 A1
(43) Pub. Date: Jan. 2, 2003

(54) Printing on front-surface layer of data recording medium

(76) Inventor: Koichi Otsuki, Nagano-ken (JP)

Correspondence Address: BEYER WEAVER & THOMAS LLP, P.O. BOX 778, BERKELEY, CA, 94704-0778, US

(21) Appl. No.: 10/182,351

(22) PCT Filed: Sep. 27, 2001
(86) PCT No.: PCT/JP01/08475

(30) Foreign Application Priority Data
Sep. 27, 2000 (JP) 2000-293195

(51) Int. Cl. B41B 1/00; G06K 1/00; G06F 15/00

(52) U.S. Cl. 358/1.13; 358/1.9

(57) ABSTRACT

The printing control apparatus comprises a user interface and a print data generator. The user interface provides a window allowing a user to select one print medium from a plurality of previously registered print mediums, and also to receive the selection by the user. The print data generator generates print data configured for the print unit to print in a predetermined printable region on the data-recording medium mounted on the tray, when the selected print medium indicates a surface layer of the data-recording medium.

### BACKGROUND OF THE INVENTION

1. Field of the Invention

The present invention relates to a technique for performing printing by forming dots on a print medium with the aid of a print head.

2. Description of the Related Art

In recent years, color printers of the type in which inks of multiple colors are ejected from an ink head have become popular as output devices for computers, and are now widely used on a regular basis. There is also a need for images to be printed with high quality on the surface of a data-recording medium such as an optical disk with the aid of such color printers.

A drawback of data-recording media such as optical disks is that these disks have a circular shape, so the printable regions of these media differ from those of common printing media. Another drawback is that because the surface layer of such data-recording media has low ink absorption, the ink tends to coalesce on the surface of the recoding medium during printing, thereby deteriorating print quality.

### SUMMARY OF THE INVENTION

Accordingly, an object of the present invention is to provide a technique for printing images on the data-recording medium in order to overcome the aforementioned drawbacks.

In order to attain the above and the other objects of the present invention, there is provided a printing control apparatus for generating print data to be supplied to a print unit to form ink dots on a print medium. The print unit is capable of printing on a data-recording medium using a tray mountable the data-recording medium. The printing control apparatus comprises a user interface and a print data generator. The user interface is configured to provide a window allowing a user to select one print medium from a plurality of previously registered print mediums, and also to receive the selection by the user. The print data generator is configured to select one print mode from a plurality of previously set print modes in response to the selected print medium, and also to generate the print data for executing printing according to the selected print mode. The print data generator is configured to generate print data configured for the print unit to print in a predetermined printable region on the data-recording medium mounted on the tray, when the selected print medium indicates a surface layer of the data-recording medium.

In the printing control apparatus of the present invention, images can be printed on a data-recording medium because print data are created such that the images are printed at predetermined positions on the surface layer of the data-recording medium when such printing is carried out.

In a preferred embodiment of the invention, the print medium has a round shape with a hole at a center of the print medium. The printable region is a ring-shaped region around the hole.

Images can thus be printed on the surface layer of a commonly used disk.

In another preferred embodiment of the invention, the plurality of previously registered print mediums include various shapes of a plurality of data-recording mediums. The tray is capable of mounting the plurality of data-recording mediums. The user interface allows the user to select one print medium from the plurality of data-recording mediums.

Images can thus be printed on the surface layers of a plurality of types of data-recording media having different configurations. It is possible to dispense with the approach in which a single tray is used (that is, the approach in which a plurality of types of data-recording media can be mounted by replacing the attachments used to mount the plurality of types of data-recording media) and to prepare a tray for each of the plurality of types of data-recording media.

In another preferred embodiment of the invention, the print data generator is configured to generate print data configured for the print unit to print in a highest print resolution available in the print unit when the selected print medium indicates the surface layer of the data-recording medium.

Ink drops can be made smaller by raising the print resolution to a higher level, making it possible to facilitate the vaporization of the ink solvent and to reduce ink coalescence.

In another preferred embodiment of the invention, the print data generator is configured to generate print data configured for the print unit to print in a unidirectional printing mode for printing during only one of forward and return passes of main scan when the selected print medium indicates the surface layer of the data-recording medium.

The coalescence of ink drops can be further reduced by selecting a unidirectional print mode, which has a slower printing speed than a bidirectional print mode.

In another preferred embodiment of the invention, the print data generator comprises a plurality of color conversion tables for converting an RGB image data indicative of tones of R, G, B to multi-tone data of multiple colors available in the print unit, and use a color conversion table achieving a minimum ink amount of all inks per unit surface area for the conversion when the selected print medium indicates the surface layer of the data-recording medium.

Using such color conversion tables allows the coalescence of ink drops to be further reduced because the maximum value of the total amount of ink ejected per unit surface area can be minimized by minimizing the limit on the total amount of ink ejected per unit surface area.

In another preferred embodiment of the invention, the print unit is capable of printing using same-hue inks having a substantially same hue and mutually different in density regarding at least one hue. The print data generator is configured to generate print data configured for the print unit to print using a comparatively richer ink rather than an ink having a leanest density among the same-hue inks regarding the one hue when the selected print medium indicates the surface layer of the data-recording medium.

The coalescence of ink drops can thus be further reduced because the amount of ink can be reduced in comparison with the use of the lowest-density ink.

In other preferred embodiment of the invention, the print data generator is configured to generate print data configured for the print unit to print at pixels next to each other in the main scan direction during nonconsecutive main scans rather than during consecutive main scans when the selected print medium indicates the surface layer of the data-recording medium.

The coalescence of ink drops in the direction of main scan can thus be reduced.

In another preferred embodiment of the invention, the print data generator is configured to generate print data configured for the print unit to print at pixels next to each other in the sub-scan direction during nonconsecutive main scans rather than during consecutive main scans when the selected print medium indicates the surface layer of the data-recording medium.

The coalescence of ink drops in the direction of sub-scan can thus be reduced.

In another preferred embodiment of the invention, the print data generator is configured to generate print data configured for the print unit to print at pixels next to each other in the inclined direction during nonconsecutive main scans rather than during consecutive main scans, the inclined direction being between directions of main scan and sub-scan when the selected print medium indicates a surface layer of the data-recording medium.

It is thus possible to reduce the coalescence of ink drops at inclined directions of main scan and sub-scan.

In another preferred embodiment of the invention, the print data generator is configured to automatically set a specific print mode with a lowest printing speed per unit surface area at least as a default setting when the selected print medium indicates the surface layer of the data-recording medium.

The coalescence of ink drops on the surface of a data-recording medium can thus be reduced because a print mode with the lowest printing speed is selected as a default setting from a plurality of print modes available.

In another preferred embodiment of the invention, the print unit comprises a sensor configured to sense the tray fed into the print unit. The tray has a sensed element configured for sensed by the sensor. The printing apparatus controls the printable region in response to the sense of the sensed element by the sensor.

The printable region can be defined with the desired accuracy on a data-recording medium by adjusting the accuracy of the position sensing for a tray based on a combination of a sensor and a sensed element.

The present invention can be realized in various forms such as a method and apparatus for printing, a method and apparatus for producing print data for a print unit, and a computer program product implementing the above scheme.

### BRIEF DESCRIPTION OF THE DRAWINGS

FIG. 1 is a perspective view depicting a printing apparatus according to an embodiment of the present invention;

FIG. 2 is a block diagram depicting the structure of a printing system as an embodiment of the present invention;

FIG. 3 is a diagram illustrating the printer structure;

FIG. 4 is a block diagram depicting the structure of the control circuit 40 in a color printer 20;

FIG. 5 is a diagram illustrating the arrangement of nozzles on the lower surface of a print head 28;

FIG. 6 is a block diagram depicting the main structure of a head drive circuit 52;

FIG. 7 is timing chart depicting the operation of the head drive circuit 52;

FIG. 8 is a diagram depicting the tray for printing images on an optical disk;

FIG. 9 is a diagram depicting a graphics software screen whose function is to enable printing on an optical disk;

FIG. 10 is a diagram illustrating the print condition setting window displayed on the display 21 of the computer 90;

FIG. 11 is a diagram illustrating the specifics of the plurality of print mode tables 104 recorded in a printer driver 96;

FIG. 12 is a diagram illustrating the basic conditions of a common interlaced recording system;

FIG. 13 is a diagram illustrating the basic conditions of an overlapped recording system;

FIG. 14 is a diagram illustrating coalescence and the manner in which it is reduced;

FIG. 15 is a diagram illustrating a first embodiment of the dot-recording system according to the present invention;

FIG. 16 is a diagram illustrating a second embodiment of the dot-recording system according to the present invention;

FIG. 17 is a diagram illustrating the dot-recording positions of each pass in the first and second embodiments of the dot-recording system according to the present invention;

FIG. 18 is a diagram illustrating a third embodiment of the dot-recording system according to the present invention;

FIG. 19 is a diagram illustrating the dot-recording positions of each pass in the second and third embodiments of the dot-recording system according to the present invention;

FIG. 20 is a diagram illustrating a fourth embodiment of the dot-recording system according to the present invention;

FIG. 21 is a diagram illustrating the dot-recording positions of each pass in the second and fourth embodiment of the dot-recording system according to the present invention; and

FIG. 22 is a diagram depicting the relation between ink duty and the recording rate of each ink.

### DESCRIPTION OF THE PREFERRED EMBODIMENT

The present invention is explained in the following sequence based on embodiments.

A. Overview of Embodiments

B. Apparatus Structure

C. Print Routines of Embodiments

D. Basic Conditions of Recording Method

E. Coalescence Prevention by Print Mode Selection

F. Coalescence Prevention by Selecting the Recording Method

G. Modifications

A. Overview of Embodiments

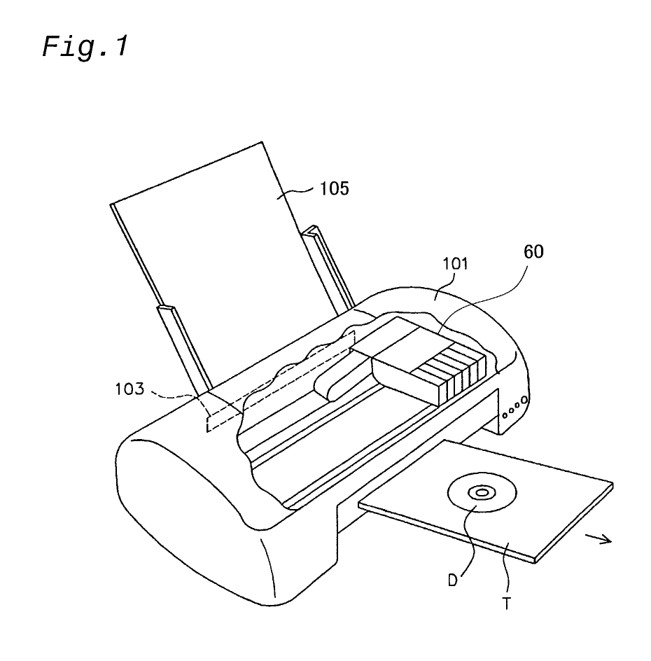

FIG. 1 is a perspective view depicting a printing apparatus according to a embodiment of the present invention. The printing apparatus comprises a casing 101, a print head unit 60, and a paper feed tray 105. The casing 101 has a manual paper feed slot 103. The paper feed slot 103 is used for printing on unbendable thin paper or optical disk D. When images are to be printed on an optical disk D, the optical disk D is mounted on an optical disk tray T and inserted into the paper feed slot 103, as shown in the drawing.

The printing apparatus has a print mode for printing images on the optical disk D. In this print mode, a print routine is performed such that ink is ejected onto specific predetermined regions of the optical disk D without being ejected in other regions. As a result, it is possible to prevent the printing apparatus from being contaminated by the ink ejected outside the optical disk D.

In this print mode, the deterioration in picture quality brought about by ink coalescence can also be reduced because ink dots are formed in a manner that enables this kind of reduction. The printing apparatus of the present invention thus allows high-quality images to be printed on a data-recording medium without contaminating the printing apparatus.

B. Apparatus Structure

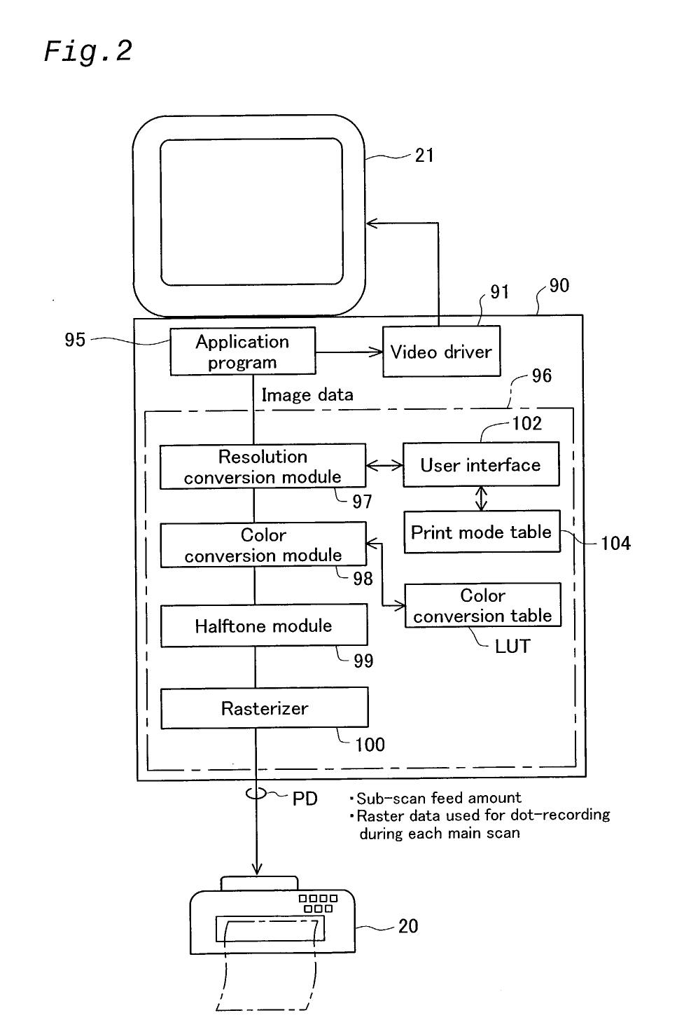

FIG. 2 is a block diagram that shows the structure of a printing system as an embodiment of the present invention. This printing system has a computer 90 as a printing control apparatus, and a color printer 20 as a print unit. The combination of color printer 20 and computer 90 can be called a “printing apparatus” in its broad definition.

Application program 95 operates on computer 90 under a specific operating system. Video driver 91 and printer driver 96 are incorporated in the operating system, and print data PD to be sent to color printer 20 is output via these drivers from application program 95. Application program 95 performs the desired processing on the image to be processed, and displays the image on CRT 21 with the aid of video driver 91.

When application program 95 issues a print command, printer driver 96 of computer 90 receives image data from application program 95, and converts this to print data PD to supply to color printer 20. In the example shown in FIG. 2, printer driver 96 includes resolution conversion module 97, color conversion module 98, Halftone module 99, rasterizer 100, and a plurality of kinds of color conversion tables LUT. The reason why the plurality of kinds of color conversion tables LUT are prepared is described below.

Resolution conversion module 97 has the role of converting the resolution (in other words, the pixel count per unit length) of the color image data handled by application program 95 to resolution that can be handled by printer driver 96. Image data that has undergone resolution conversion in this way is still image information made from the three colors RGB. Color conversion module 98 converts RGB image data to multi-tone data of multiple ink colors that can be used by color printer 20 for each pixel while referencing color conversion table LUT.

The color converted multi-tone data can have a tone value of 256 levels, for example. Halftone module 99 executes halftone processing to express this tone value on color printer 20 by distributing and forming ink dots. Image data that has undergone halftone processing is realigned in the data sequence in which it should be sent to color printer 20 by rasterizer 100, and ultimately is output as print data PD. Print data PD includes raster data that shows the dot-recording state during each main scan and data that shows the sub-scan feed amount.

Printer driver 96 is a program for realizing a function that generates print data PD. A program for realizing the functions of printer driver 96 is supplied in a format recorded on a recording medium that can be read by a computer. As this kind of recording medium, any variety of computer readable medium can be used, including flexible disks, CD-ROMs, opt-magnetic disks, IC cards, ROM cartridges, punch cards, printed items on which a code such a bar code is printed, a computer internal memory device (memory such as RAM or ROM), or external memory device, etc.

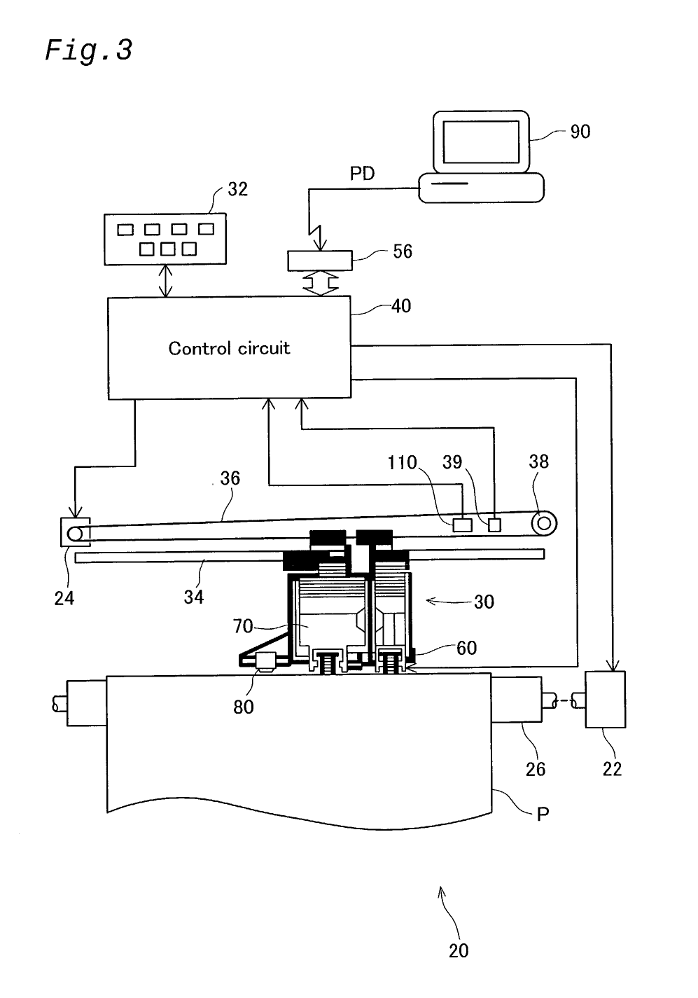

FIG. 3 is a schematic structural diagram of color printer 20. Color printer 20 is equipped with a sub-scan feed mechanism that carries printing paper P in the sub-scan direction using paper feed motor 22, a main scan feed mechanism that sends cartridge 30 back and forth in the axial direction of platen 26 using carriage motor 24, a head driving mechanism that drives printing head unit 60 built into carriage 30 and controls ink ejecting and dot formation, and control circuit 40 that controls the interaction between the signals of paper feed motor 22, carriage motor 24, printing head unit 60, and operating panel 32. Control circuit 40 is connected to computer 90 via connector 56.

The sub-scan feed mechanism that carries printing paper P is equipped with a gear train (not illustrated) that transmits the rotation of paper feed motor 22 to paper carriage roller (not illustrated). Also, the main scan feed mechanism that sends carriage 30 back and forth is equipped with sliding axis 34 on which is supported carriage 30 so that it can slide on the axis and that is constructed in parallel with the axis of platen 26, pulley 38 on which is stretched seamless drive belt 36 between the pulley and carriage motor 24, and position sensor 39 that detects the starting position of carriage 30.

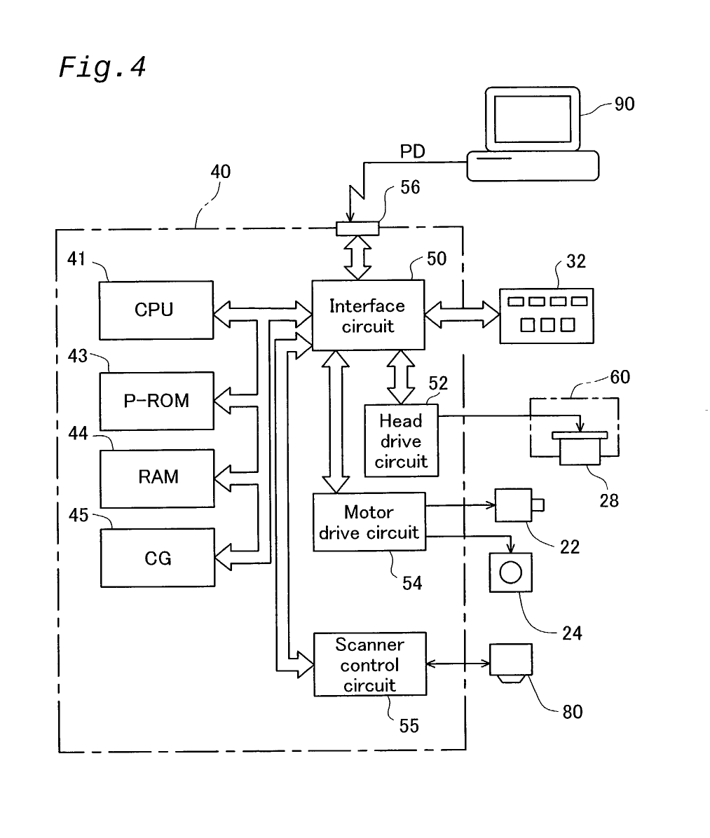

FIG. 4 is a block diagram that shows the structure of color printer 20, the core of which is control circuit 40. Control circuit 40 is formed as an arithmetic and logic operating circuit that is equipped with CPU 41, programmable ROM (PROM) 43, RAM 44, and character generator (CG) 45 that stores the dot matrix of the characters. This control circuit 40 is further equipped with an interface circuit 50 that works exclusively as an interface with external motors, etc., head drive circuit 52 connected to this interface circuit 50 that drives printing head unit 60 and ejects ink, motor drive circuit 54 that drives paper feed motor 22 and carriage motor 24, and scanner control circuit 55 that controls scanner 80. Interface circuit 50 has a built in parallel interface circuit, and can receive print data PD supplied from computer 90 via connector 56. Color printer 20 executes printing according to this print data PD. RAM 44 functions as buffer memory for temporarily storing raster data.

Printing head unit 60 has printing head 28, and holds an ink cartridge. Printing head unit 60 can be attached and detached from color printer 20 as one part. In other words, printing head 28 is replaced together with printing head unit 60.

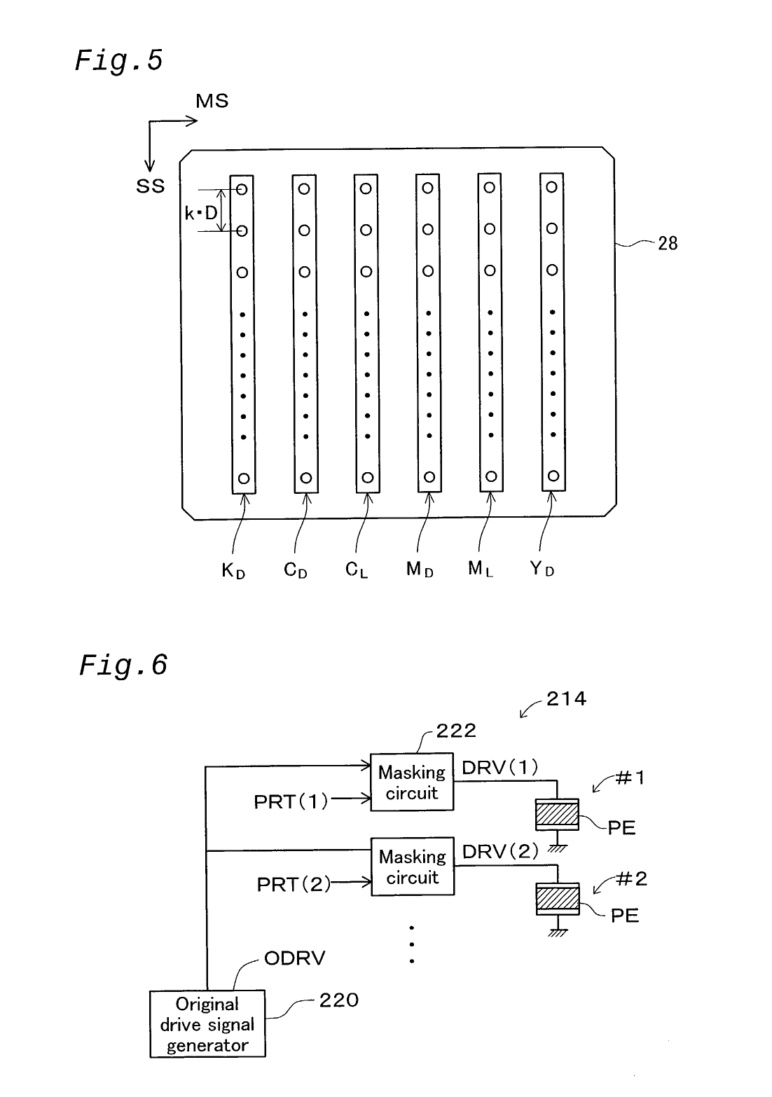

FIG. 5 is an explanatory diagram that shows the nozzle array on the bottom surface of printing head 28. Formed on the bottom surface of printing head 28 are black ink nozzle group KD for ejecting black ink, dark cyan ink nozzle group CD for ejecting dark cyan ink, light cyan ink nozzle group CL for ejecting light cyan ink, dark magenta ink nozzle group MD for ejecting dark magenta ink, light magenta ink nozzle group ML for ejecting light magenta ink, and yellow ink nozzle group YD for ejecting yellow ink.

The upper case alphabet letters at the beginning of the reference symbols indicating each nozzle group means the ink color, and the subscript “D” means that the ink has a relatively high density and the subscript “L” means that the ink has a relatively low density.

The multiple nozzles of each nozzle group are each aligned at a fixed nozzle pitch k·D along sub-scan direction SS. Here, k is an integer, and D is the pitch (called “dot pitch”) that correlates to the printing resolution in the sub-scan direction. In this specification, we also say “the nozzle pitch is k dots.” The “dot” unit means the dot pitch of print resolution. Similarly, the “dot” unit is used for sub-scan feed amount as well.

Each nozzle is provided with a piezoelectric element (not illustrated) as a drive component that drives each nozzle to eject ink drops. Ink drops are ejected from each nozzle while printing head 28 is moving in main scan direction MS.

Multiple nozzles of each nozzle group do not have to be arrayed in a straight line along the sub-scan direction, but can also be arrayed in a zigzag, for example. Even when the nozzles are arrayed in a zigzag, the nozzle pitch k·D measured in the sub-scan direction can be defined in the same way as the case shown in FIG. 5. In this specification, the phrase “multiple nozzles arrayed along the sub-scan direction” has a broad meaning that includes nozzles arrayed in a zigzag.

FIG. 6 is a block diagram that shows the main configuration of head drive circuit 52 (FIG. 4). Head drive circuit 52 is equipped with drive signal generator 220, masking circuits 222, and piezoelectric element PE for each nozzle. Masking circuits 222 are provided for each nozzle #1, #2, . . . of printing head 28. In addition, in FIG. 6, the number in parentheses added at the end of the signal names show the ordinal number of the nozzle to which that signal is supplied.

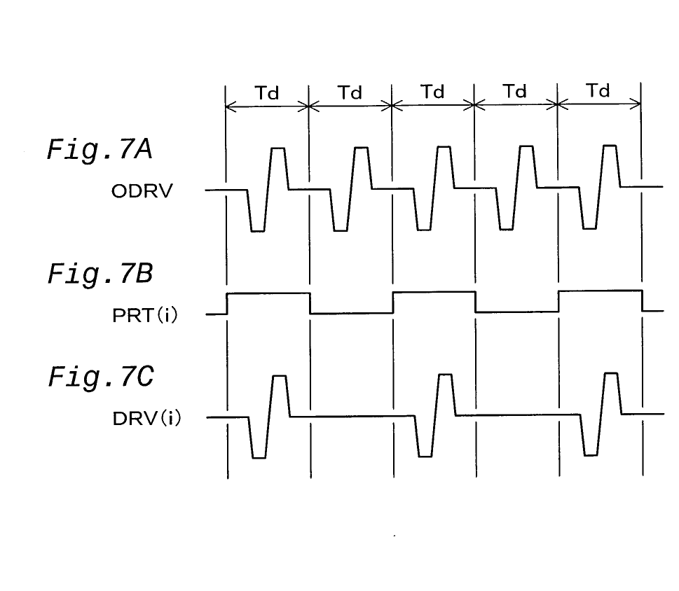

Drive signal generator 220 generates the original drive signal COMDRV (FIG. 7A) used in common by each nozzle and supplies this to masking circuits 222. This original drive signal COMDRV is a signal that includes one pulse in one pixel period Td as shown in FIG. 7B, for example. The i-th masking circuit 222 masks original drive signal COMDRV according to the level of serial printing signal PRT (i) of the i-th nozzle. Specifically, masking circuits 222 pass original drive signal COMDRV as is when printing signal PRT (i) is level 1, thereby supplying it to piezoelectric element PE as drive signal DRV. Meanwhile, when the printing signal PRT (i) is level 0, original drive signal COMDRV is blocked. This serial printing signal PRT (i) indicates the recording state of each pixel during one main scan by the i-th nozzle. This signal PRT(i) is derived from print data PD (FIG. 3) given from computer 90. FIG. 7A to 7C show an example of when dots are recorded every other pixel. When dots are recorded for all pixels, original drive signal COMDRV is supplied as is to piezoelectric element PE as drive signal DRV.

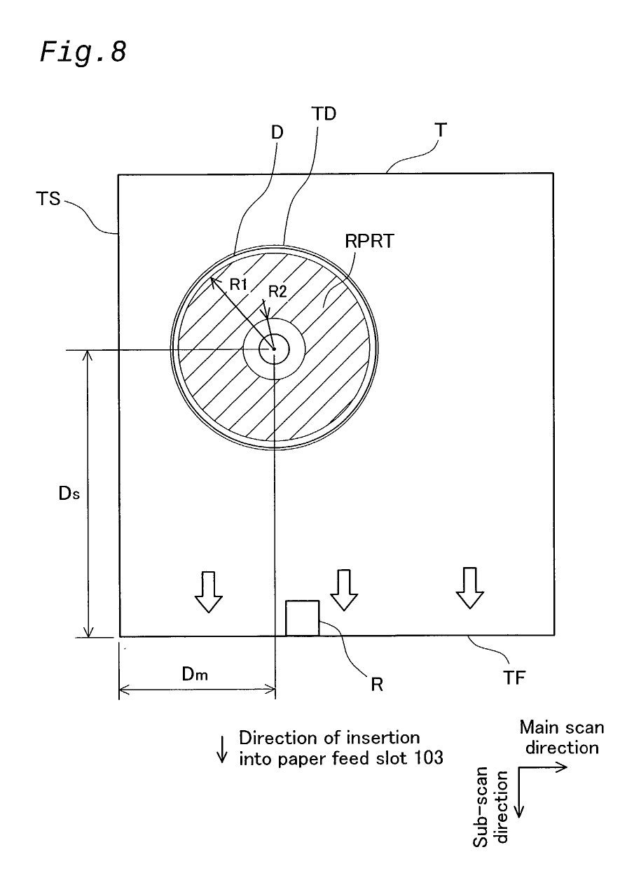

FIG. 8 is a diagram depicting a tray for printing on an optical disk. The tray comprises a sensed element R and a depression TD for mounting optical disks. The depression TD for mounting optical disks is a circular indent in the tray for mounting optical disks. This indent is designed to position the surface layer of the optical disk D flush with the tray surface. The gap between the print head 28 and the surface layer of the optical disk during printing can thus be made equal to the gaps maintained when images are printed on other print media.

The hatched ring-shaped region RPRT of the optical disk D mounted on the tray is the printable region. The region RPRT is established using the tray as reference. Specifically, the ring-shaped region extending from radius R2 to radius R1 and having its center at a point shifted away from the front end TF of the tray by a first distance Ds in the direction of sub-scan, and a second distance Dm away from the lateral left side TS of the tray in the direction of main scan, is established as a printable region RPRT.

The positioning control of the optical disk D in the printing apparatus is performed in the following manner. The sensed element R of the tray T is sensed by a sensor (not shown) provided to the printer 20 when the tray T carrying the mounted optical disk D is inserted into the paper feed slot 103 (FIG. 1) and fed in the direction of sub-scan. The printer 20 is configured such that the position of the tray T in the direction of sub-scan can be controlled based on the sensing position in the direction of sub-scan. The position of the tray T in the direction of main scan can be determined by the width of the paper feed slot 103.

Thus, the printing apparatus is configured such that images can be printed on the surface layer of the optical disk D with the aid of the tray T. The positional accuracy of printing on the optical disk D can also be raised by improving the measurement accuracy of the tray T in the direction of sub-scan through the use of a combination comprising the sensed element of the tray T and the sensor of the printer 20.

The shape of the optical disk is not limited to circular and may be varied including rectangular (in the form of a business card). The printable region RPRT (FIG. 8) can be set in each case in accordance with the shape of the optical disk.

A color printer 20 having this type of hardware configuration operates such that the carriage 30 is reciprocated by a carriage motor 24 while paper P is transported by a paper feed motor 22. At the same time, the piezo-elements of the print head 28 are actuated, ink drops of each color are ejected, ink dots are formed, and multicolored, multi-gradation images are formed on the paper P.

C. Print Routines of Embodiments

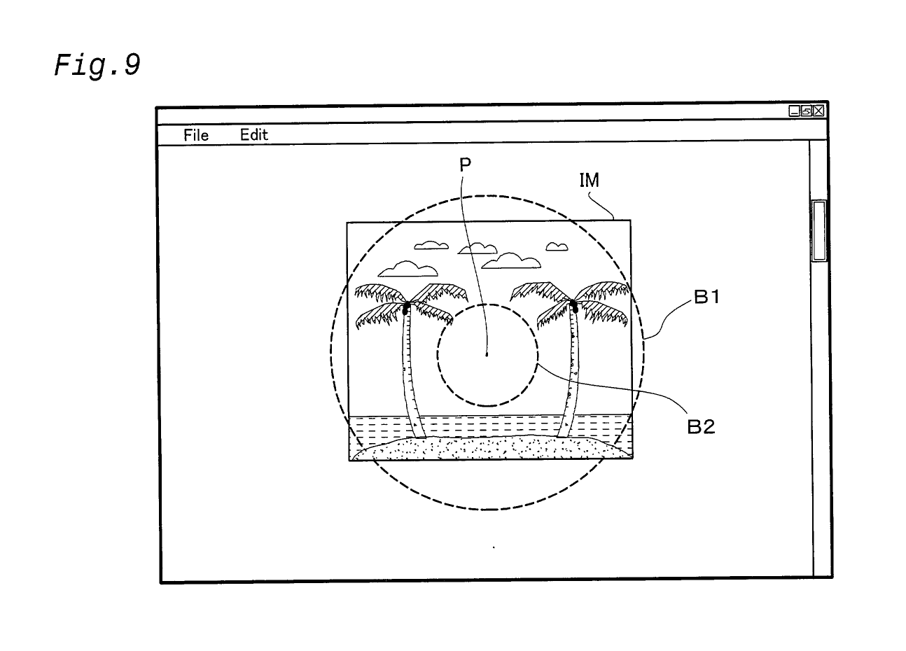

FIG. 9 is a diagram depicting a graphics software screen whose function is to enable printing on an optical disk. The screen displays the image IM to be printed on the surface layer of the optical disk, two dotted lines B1 and B2 for indicating the printable region of the optical disk, and a point P for indicating the center position of the optical disk. The user can adjust the size and position of the image IM on the screen while referring to the two dotted lines B1 and B2 for indicating the printable region.

Visual data are sent from the application to the printer driver 96 when the adjustment is completed and printing is instructed on the screen shown in FIG. 2. A print mode for enabling printing on CD-R as a print medium is automatically selected. In this embodiment, the graphics software screen functions as the user interface referred to in the claims.

The video data are created as data related to a system of coordinates in which the point P for indicating the center position of the optical disk is used as the origin. The printer driver 96 shifts the system of coordinates and creates print data PD with reference to the positional relation of the optical disk on the tray and to the detection position of the tray T in the direction of sub-scan. The print mode can also be established on the screen manually in the manner described below. In this case, the screen described below functions as the user interface referred to in the claims.

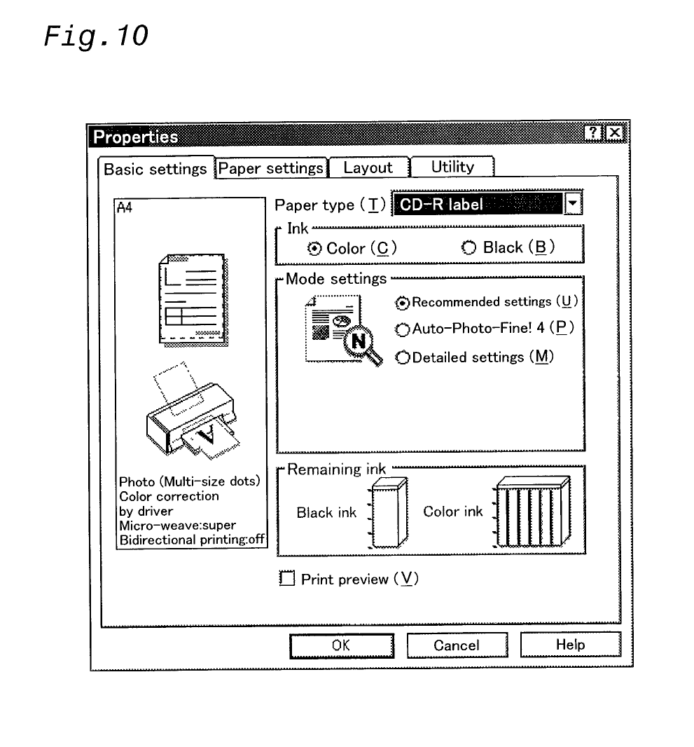

FIG. 10 is a diagram illustrating the print condition setting window displayed on the display 21 of the computer 90 by the user interface 102 of the printer driver 96. The user can select the type of print medium (also referred to as “printing paper”), the use of color inks, and the print mode settings as basic settings for the printing conditions.

Plain paper, photo-print paper, OHP sheets, and a plurality of other types of media can be prerecorded in addition to CD-Rs and other types of optical disks (data-recording media) as such print media. The user can select the desired print medium from among this plurality of types of print media.

A group of settings can be selected as mode settings from the following three groups: recommended settings (default settings), Auto-Photo-Fine settings, and detailed settings. With the recommended settings, a print mode suitable for the print medium selected by the user is set automatically. A variety of settings needed to print photographic images with high quality are automatically selected in the case of the Auto-Photo-Fine settings. The detailed settings allow the user to arbitrarily select various settings.

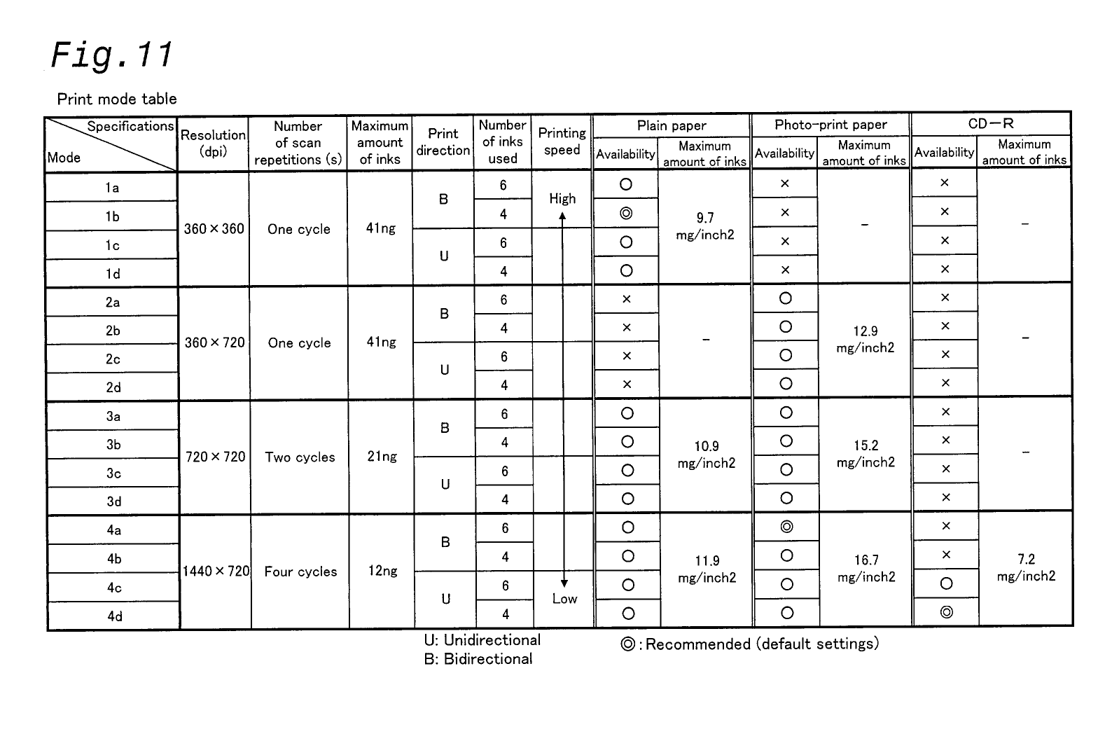

FIG. 11 is a diagram illustrating the specifics of the plurality of print mode tables 104 recorded in the printer driver 96. These print mode tables contain a total of 16 print modes, from mode 1a to mode 4d. The following four settings can be used as print resolutions: 360×360 dpi, 360×720 dpi, 720×720 dpi, and 1440×720 dpi. Each of these print resolutions can be expressed as (Resolution in main scan direction)×(Resolution in sub-scan direction). The “maximum ink weight” indicated in the table in FIG. 3 refers to the maximum weight of ink dots selected from among a plurality of types of ink dots that can be used at each resolution. The weight of ink commonly decreases with increased print resolution. Consequently, individual ink dots tend to dry faster with increased print resolution.

Four print modes can be set up for a single print resolution, depending on the printing direction (unidirectional or bidirectional) and the number of inks used (six or four colors). Four types of inks (CMYK) are used when the number of inks used corresponds to four colors, and light cyan and light magenta inks are used in addition to the four types of inks (CMYK) when six colors are involved.

The printing speed commonly increases with a reduction in the number of scan cycles (see below) and a reduction in print resolution, and is higher for bidirectional printing than for unidirectional printing. Consequently, the 360×360 dpi bidirectional print modes 1a and 1b with a small number of scan cycles have the highest printing speed, and the 1440×720 dpi unidirectional print modes 4c and 4d with a large number of scan cycles have the lowest printing speed among the 16 print modes shown in FIG. 3. Ink dots tend to dry more easily at lower printing speeds, and are thus less likely to coalesce.

The right-side half of FIG. 11 depicts the relation between the type of print medium and the print mode that can be selected. In FIG. 11, double circles are used to designate modes selected in accordance with a print medium that conforms to recommended settings (FIG. 2), and single circles are used to designate modes that can be selected by the user in accordance with detailed settings. For example, the recommended settings produce mode 1b (360×360 dpi; bidirectional, four-color printing) when plain paper has been selected as the print medium. In the case of plain paper, the user cannot select any of the four modes 2a-2d with 360×720 dpi. The recommended settings produce mode 4d (1440×720 dpi; unidirectional, four-color printing) when an optical disk has been selected as the print medium. In the case of an optical disk, the user can select only the two modes 4c and 4d, which have the lowest printing speed. With the recommended settings (default settings) of the print modes, a single print mode is thus selected in advance in accordance with the type of print medium (specifically, the material of the print medium).

The “maximum amount of ink” indicated in the print medium columns refers to the limit on the total amount of ink per unit surface area. In FIG. 3, the print modes are classified in accordance with only three parameters: print resolution, print direction, and the number of inks used. Consequently, the maximum amount of ink and other parameters can sometimes vary with the print medium even in the same print mode. Specifically, the maximum amount in which ink is used in print mode 4d is 11.9 mg/inch² for plain paper, 16.7 mg/inch² for photo-print paper, and 7.2 mg/inch² for optical disks. Specifically, the limit on the maximum amount of ink is set lower when images are printed an optical disk than when images are printed on another print medium. In other words, the total amount of ink per unit surface area is less during printing on an optical disk than during printing on another print medium, so the ink can dry faster and the droplets are less likely to coalesce with each other.

According to the present embodiment, print modes are classified in accordance with three parameters (print resolution, print direction, and the number of inks used), but the print modes can be further subdivided using other parameters (for example, the maximum amount of ink).

The present embodiment thus allows mode 4d (which has the lowest printing speed) to be selected as a recommended setting from the print modes 1a-4d employed by the printer 20 during printing on an optical disk, with the result that the ink can dry faster and the drops are less likely to coalesce with each other. Print mode 4d has the highest print resolution, and is hence advantageous in being able to produce lightweight ink drops and allowing the ink to dry faster. In addition, print mode 4d has the lowest limit on the total amount of ink per unit surface area, and this feature also facilitates ink drying and impedes ink coalescence.

Print mode 4d is performed using comparatively dense inks alone for cyan and magenta, without any light inks being used, making it possible to reduce the amount of ink in comparison with cases in which light inks are used. This approach reinforces the effect of facilitating ink drying and impeding ink coalescence.

According to the present embodiment, mode 4d (which is characterized by having the highest print resolution, entailing unidirectional printing, dispensing with the use of light inks, and keeping the maximum amount of ink at the lowest level) is automatically selected as the print mode that corresponds to the recommended settings during printing on an optical disk. It is also possible, however, to adopt an arrangement in which a print mode lacking at least some of these features is automatically pre-selected as a recommended setting for an optical disk.

D. Basic Conditions of the Recording Method:

Before giving a detailed explanation of the recording method used in the embodiments of the present invention, first, the basic conditions of a normal interlace recording method is explained hereafter. An “interlace recording method” means a recording method that is used when the nozzle pitch k in the sub-scan direction is two or greater. With an interlace recording method, with one main scan, a raster line that cannot be recorded is left between adjacent nozzles, and the pixels on this raster line are recorded during another main scan. In this specification, “printing method” and “recording method” are synonyms.

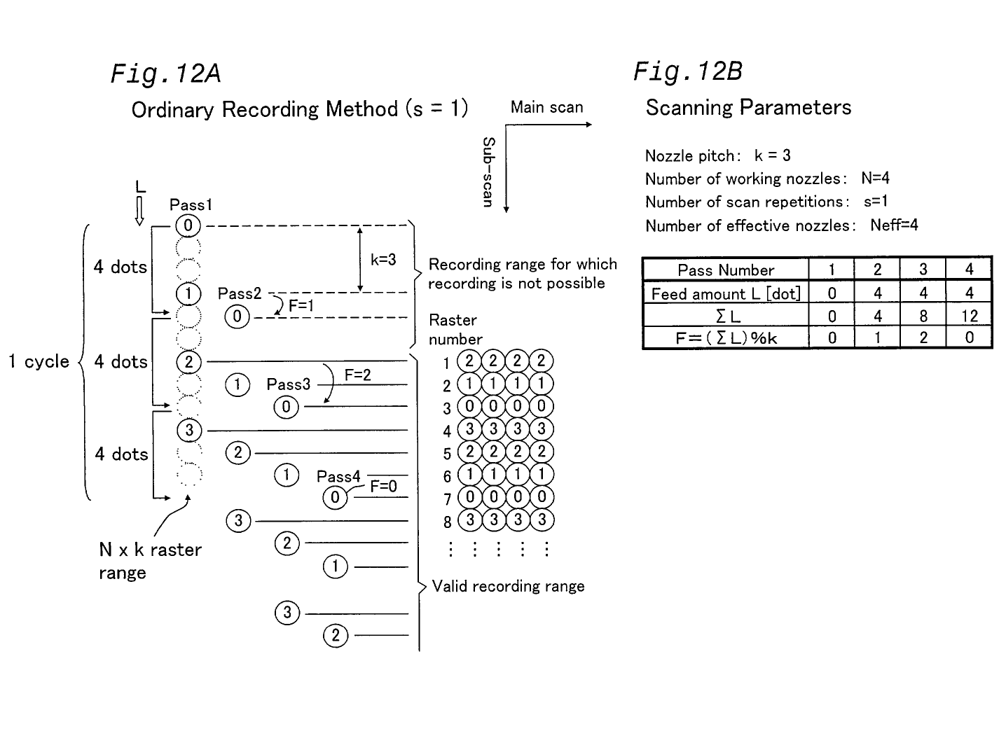

FIG. 12A shows an example of sub-scan feed on the basic conditions of a normal interlace recording method, and FIG. 12B shows the parameters of that dot-recording on the basic conditions. In FIG. 12A, the solid line circle around the numbers indicates positions of the four nozzles in the sub-scan direction for each pass. The term “pass” means one main scan. The numbers 0 through 3 in the circles indicate the nozzle numbers. The positions of the four nozzles shift in the sub-scan direction each time one main scan ends. However, in reality, the sub-scan direction feed is realized by movement of the paper by paper feed motor 22 (FIG. 3).

As shown at the left side of FIG. 12A, sub-scan feed amount L is a fixed value of four dots in this example. Therefore, each time a sub-scan feed is done, the position of the four nozzles shifts by four dots each in the sub-scan direction. Each nozzle has as a recording target all dot positions (also called “pixel positions”) on each raster line during one main scan. In this specification, the total number of main scans performed on each raster line (also called “main scan lines”) is called “scan repetition count s.”

At the right side of FIG. 12A is shown the ordinal number of the nozzle that records dots on each raster line. With the raster lines drawn by a dotted line extending in the right direction (main scan direction) from the circles that indicate the sub-scan direction position of the nozzles, at least one of the raster lines above or below this cannot be recorded, so in fact, dot-recording is prohibited. Meanwhile, the raster lines drawn by a solid line extending in the main scan direction are in a range for which dots can be recorded on the raster lines before and after them. The range for which recording can actually be done will hereafter be called the valid recording range (or “valid printing range,” “printing execution area,” or “recording execution area”).

In FIG. 12B, various parameters relating to this dot-recording method are shown. Dot recording method parameters include nozzle pitch k (dots), the number of working nozzles N, the scan repetition count s, the effective nozzle count Neff, and sub-scan feed amount L (dots).

In the example in FIGS. 12A and 12B, nozzle pitch k is 3 dots. Number of working nozzles N is 4. Also, number of working nozzles N is the number of nozzles actually used among the multiple nozzles that are installed. Scan repetition count s means that main scans are executed s times on each raster line. For example, when scan repetition count s is two, main scans are executed twice on each raster line. At this time, normally dots are formed intermittently at every other dot position on one main scan. In the case shown in FIGS. 12A and 12B, the scan repetition count s is one. The effective nozzle count Neff is a value of working nozzle number N divided by scan repetition count s. This effective nozzle count Neff can be thought of as showing the net number of the raster lines for which dot-recording is completed with one main scan.

In the table in FIG. 12B, the sub-scan feed amount L, its sum value Σ L, and nozzle offset F are shown for each pass. Here, offset F indicates how many dots the nozzle position is separated in the sub-scan direction from the reference positions for each pass; the reference positions for which the offset is zero are cyclical positions of the nozzles (in FIGS. 12A and 12B, a position every three dots) at the first pass. For example, as shown in FIG. 12A, after pass 1, the nozzle position moves in the sub-scan direction by sub-scan feed amount L (4 dots). Meanwhile, nozzle pitch k is 3 dots. Therefore, the nozzle offset F for pass 2 is 1 (see FIG. 12A). Similarly, the nozzle position for pass 3 is moved from the initial position by ΣL=8 dots, and the offset F is 2. The nozzle position for pass 4 moves ΣL=12 dots from the initial position, and the offset F is 0. With pass 4 after three sub-scan feeds, nozzle offset F returns to 0, and by repeating a cycle of three sub-scans, it is possible to record dots on all raster lines in the valid recording range.

As can be understood from the example in FIGS. 12A and 12B, when the nozzle position is in a position separated by an integral multiple of nozzle pitch k from the initial position, offset F is 0. In addition, offset F can be given by remainder (ΣL) % k, which is obtained by dividing cumulative value ΣL of sub-scan feed amount L by nozzle pitch k. Here, “%” is an operator that indicates that the division remainder is taken. If we think of the nozzle initial position as a cyclical position, we can also think of offset F as showing the phase shift amount from the initial position of the nozzle.

When the scan repetition count s is 1, to have no gaps or overlap in the raster line that is to be recorded in the valid recording range, the following conditions must be met.

Condition c1: The number of sub-scan feeds of one cycle is equal to nozzle pitch k.

Condition c2: Nozzle offset F after each sub-scan feed in one cycle assumes a different value in a range from 0 to (k·1).

Condition c3: The average sub-scan feed amount (ΣL/k) is equal to the working nozzle number N. In other words, the cumulative value ΣL of sub-scan feed amount L per cycle is equal to the working nozzle number N multiplied by nozzle pitch k, (N×k).

Each of the aforementioned conditions can be understood by thinking as follows. There are (k·1) raster lines between adjacent nozzles. In order for a nozzle to return to the reference position (position where offset F is 0) while performing recording on these (k·1) raster lines during one cycle, the number of sub-scan feeds in one cycle will be k. If the number of sub-scan feeds in one cycle is less than k, there will be gaps in the recorded raster lines, and if there are more than k sub-scan feeds in one cycle, there will be overlap in the recorded raster lines. Therefore, the aforementioned first condition c1 is established.

When the number of sub-scan feeds in one cycle is k, gaps and overlaps in the recorded raster lines are eliminated only when the values of offset F after each sub-scan feed are different from each other in the range 0 to (k·1). Therefore, the aforementioned second condition c2 is established.

If the aforementioned first and second conditions are established, during one cycle, recording of k raster lines will be performed for each of N nozzles. Therefore, with one cycle, recording of N×k raster lines is performed. Meanwhile, if the aforementioned third condition c3 is met, as shown in FIG. 12A, the nozzle position after one cycle (after k sub-scan feeds) comes to a position separated by N×k raster lines from the initial nozzle position. Therefore, by fulfilling the aforementioned first through third conditions c1 to c3, it is possible to eliminate gaps and overlaps in the range of these N×k raster lines.

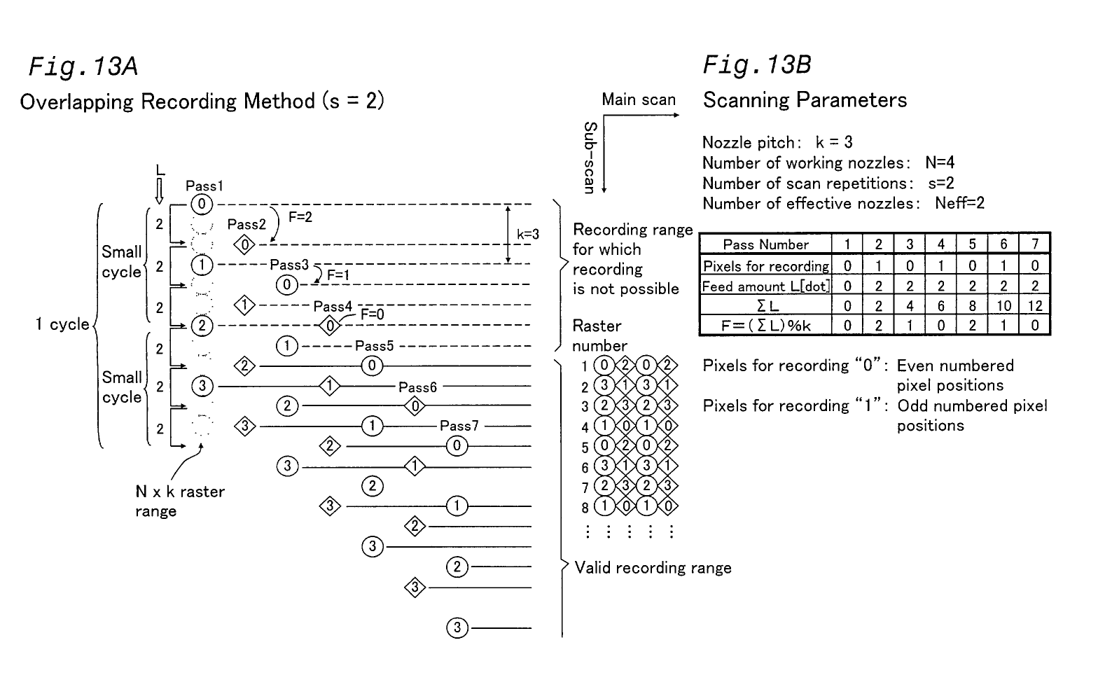

FIGS. 13A and 13B show the basic conditions of a dot-recording method when the scan repetition count s is two. Hereafter, we will call a dot-recording method for which the scan repetition count s is 2 or greater an “overlapping method”. FIG. 13A shows an example of sub-scan feed of the overlapping interlace recording method, and FIG. 13B shows its parameters. When the scan repetition count s is 2 or greater, main scanning is executed s times on the same raster line.

The dot-recording method shown in FIGS. 13A and 13B has a different scan repetition count s and sub-scan feed amount L for the parameters of the dot-recording method shown in FIG. 12B. As can be seen from FIG. 13A, the sub-scan feed amount L of the dot-recording method in FIGS. 13A and 13B is a fixed value of 2 dots. In FIG. 13A, the positions of nozzles at even numbered passes are shown by a diamond shape. Normally, as shown at the right side of FIG. 13A, the recorded dot positions on even numbered passes are shifted by one dot in the main scan direction from those on the odd numbered passes. Therefore, multiple dots on the same raster line are intermittently recorded by two different nozzles. For example, the topmost raster line within the valid recording range is intermittently recorded every other dot by the #0 nozzle on pass 5 after intermittent recording is done every other dot by the #2 nozzle on pass 2. With this overlapping method, each nozzle is driven with intermittent timing so that (s·1) dot-recording is prohibited after 1 dot is recorded during one main scan.

In this way, the overlapping method that has intermittent pixel positions on a raster line as a recording target during each main scan is called an “intermittent overlapping method”. Also, instead of having intermittent pixel positions as the recording target, it is also possible to have all pixel positions on a raster line during each main scan be the recording target. In other words, when executing a main scan s times on one raster line, it is allowable to overstrike dots on the same pixel position. This kind of overlapping method is called an “overstrike overlapping method” or “complete overlapping method”.

With an intermittent overlapping method, it is acceptable, as far as the target pixel positions of the multiple nozzles on the same raster line are shifted in relation to each other, so for the actual shift amount in the main scan direction during each main scan, a variety of shift amounts other than that shown in FIG. 13A are possible. For example, it is also possible to record dots in the positions shown by circles without shifting in the main scan direction on pass 2, and to record the dots in the positions shown by diamonds with the shift in the main scan direction performed on pass 5.

The value of offset F of each pass in one cycle is shown at the bottom of the table in FIG. 13B. One cycle includes six passes, and offset F for pass 2 to pass 7 includes a value in the range of zero to two twice each. Also, the change in offset F for three passes from pass 2 to pass 4 is equal to the change in offset F for three passes from pass 5 to pass 7. As shown at the left side of FIG. 13A, the six passes of one cycle can be segmented into two small cycles of three passes each. At this time, one cycle ends by repeating a small cycle s times.

Generally, when scan repetition count s is an integer of two or greater, the first through third conditions c1 through c3 described above can be rewritten as the following conditions c1′ through c3′.

Condition c1′: The sub-scan feed count of one cycle is equal to the multiplied value of nozzle pitch k and scan repetition count s, (k×s).

Condition c2′: Nozzle offset F after each of the sub-scan feeds in one cycle assumes a value in the range of 0 through (k·1), and each value is repeated s times.

Condition c3′ The sub-scan average feed amount {ΣL/(k×s)} is equal to effective nozzle count Neff (=N/s). In other words, cumulative value ΣL of sub-scan feed amount L per cycle is equal to the multiplied value of effective nozzle count Neff and the sub-scan feed count (k×s), {Neff×(k×s)}.

The aforementioned conditions c1′ through c3′ also holds when scan repetition count s is one. Therefore, conditions c1′ to c3′ can be thought of as conditions that are generally established in interlace recording methods regardless of the value of scan repetition count s. In other words, if the aforementioned three conditions c1′ through c3′ are satisfied, it is possible to eliminate gaps and unnecessary overlaps for recorded dots in the valid recording range. However, when using the intermittent overlapping method, a condition is required whereby the recording positions of nozzles that record on the same raster line are shifted in relation to each other in the main scan direction. In addition, when using an overstrike overlapping method, it is enough to satisfy the aforementioned conditions c1′ to c3′ and for each pass, all pixel positions are subject to recording.

In FIGS. 12A, 12B, 13A, and 13B, cases when sub-scan feed amount L is a fixed value are explained, but the aforementioned conditions c1′ to c3′ can be applied not only in cases when sub-scan feed amount L is a fixed value, but also in cases of using a combination of multiple different values as the sub-scan feed amount. Note that in this specification, sub-scan feeds for which feed amount L is a fixed value are called “constant feeds,” and sub-scan feeds that use combinations of multiple different values as the feed amount are called “variable feeds.”

E. Coalescence Prevention by Print Mode Selection

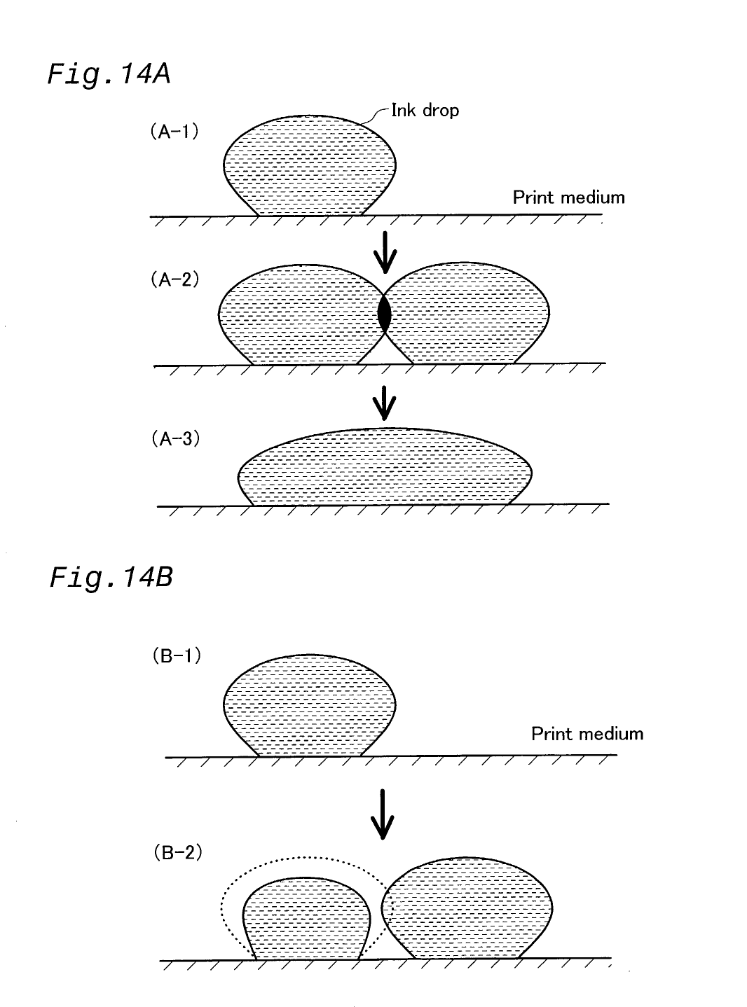

FIG. 14 is a diagram illustrating coalescence and the manner in which it is reduced. FIG. 14A is a diagram depicting the coalescence process, and FIG. 14B is a diagram depicting a coalescence-free condition. In FIG. 14A, “(a-1)” depicts a state in which an ink drop ejected from a nozzle is deposited at a certain position on a print medium. In the same drawing, “(a-2)” depicts a state in which an ink drop is deposited on an adjacent pixel before the previous ink drop has decreased in size as a result of being vaporized or absorbed on the print medium. As used herein, the term “adjacent pixels” refers to two or more pixels having at least one common point or side and abutting in the direction of sub-scan, the direction of main scan, or an inclined direction intermediate between the direction of main scan and the direction of sub-scan. In this case, two ink drops combine and form a larger ink drop, as shown in (a-3). A state in which ink drops continuously combine with each other in this manner is referred to as ink coalescence. Such coalescence results in reduced picture quality. In particular, coalescence is facilitated and picture quality decreases for print media with poor ink absorption, such as the synthetic resins commonly used for data-recording media.

The dotted lines in the (b-1) portion of FIG. 14B depict a state in which an ink drop ejected from a nozzle is deposited at a certain position on a print medium. In the same drawing, “(b-2)” depicts a state in which an ink drop is deposited on an adjacent pixel after the previously ejected ink drop has decreased in size as a result of being vaporized or absorbed on the print medium. It can be seen in (b-2) that the ink drop on the right remains separate because the ink drop on the left has already become smaller.

Thus, adopting an approach in which an ink drop is deposited onto a pixel and another ink drop is deposited onto an adjacent pixel only after sufficient time has elapsed prevents these two ink drops from uniting with each other and results in reduced coalescence. For this reason, a print mode with unidirectional printing (rather than bidirectional printing) should preferably be selected. In addition, selecting a higher print resolution reduces the size of ink drops, and hence facilitates drying. It is therefore more desirable to select a print mode that has higher resolution. It can thus be seen that, in preferred practice, a specific print mode with a low printing speed should be automatically selected in accordance with the print medium.

When the data-recording medium is selected through the selection of the print medium in the print condition setting window (FIG. 10) in this manner, the range of print mode selections should be automatically reduced to allow a selection to be made automatically in accordance with the print mode. In the example shown, selecting a data-recording medium as the print medium allows only a specific print mode 4c or 4d with the lowest printing speed to be selected from the print mode tables 104 (FIG. 11). In the case of the next slowest print modes 4a and 4b, the selection is made from these specific print modes to allow high-quality images to be printed on the data-recording medium. In this case, a specific slow print mode 4c or 4d should preferably be selected from the print mode tables if the recommended settings are selected through mode settings.

As described above, the present invention is devised such that a print medium with the lowest printing speed per unit surface area is automatically set when a data-recording medium such as an optical disk is set as the print medium. As a result, the coalescence-induced reduction in picture quality can be controlled and print quality can be improved even when images are printed on a data-recording medium with poor ink absorption. In this print mode, even higher print quality can be attained by adopting a dot-recording system or a color conversion table LUT suitable for printing on data-recording media.

F. Coalescence Prevention by Selecting the Recording Method

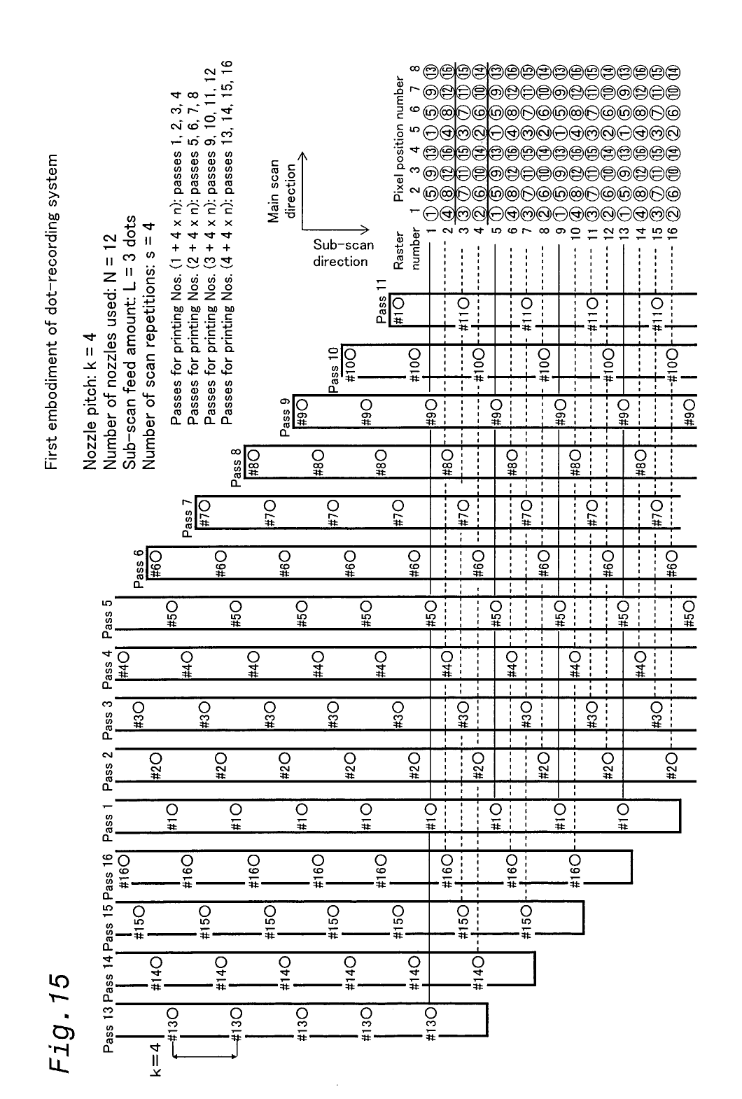

FIG. 15 is a diagram illustrating a first embodiment of the dot-recording system according to the present invention. This dot-recording system has the following parameters: N=12, k=4, L=3, and s=4. These parameters satisfy the above-described conditions c1′-c3′. It is therefore possible to perform printing without any omissions or unnecessary overlapping involving recorded dots. In addition, the nozzle pitch k is 4, and so is the number of scan cycles s, so each cycle contains 16 passes, as described with reference to the basic conditions of the recording system. FIG. 15 depicts some of the 16 passes contained in the cycle.

The pixel position numbers on the right-side edge of FIG. 15 indicate the order in which the pixels are arranged along each raster line, and the numbers in circles indicate the numbers for the passes responsible for forming dots at these pixel positions. For example, dots are formed during four passes (Nos. 1, 5, 9, 13) on the first raster line. Specifically, it is indicated for the first raster line that the dots whose pixel position numbers are (1+4×n) are formed during pass No. 1, the dots whose pixel position numbers are (2+4×n) are formed during pass No. 5, the dots whose pixel position numbers are (3+4×n) are formed during pass No. 9, and the dots whose pixel position numbers are (4+4×n) are formed during pass No. 13. Similarly, the dots on the second raster line are formed during pass Nos. 4, 8, 12, and 16; the dots on the third raster line are formed during pass Nos. 3, 7, 11, and 15; and the dots on the fourth raster line are formed during pass Nos. 2, 6, 10, and 14. Thus, raster line No. (1+3×m) is formed during pass Nos. 1, 5, 9, and 13; raster line No. (2+3×m) is formed during pass Nos. 4, 8, 12, and 16; raster line No. (3+3×m) is formed during pass Nos. 3, 7, 11, and 15; and raster line No. (4+3×m) is formed during pass Nos. 2, 6, 10, and 14. In the present specification, m an n are normegative integers.

The raster lines are formed by controlling the timing of print signals PRT(i) (FIG. 7). Specifically, the control procedure should be performed such that, for example, the print signals PRT(i) are outputted solely at pixel position Nos. (1+4×n) during pass No. 1 in order to form dots over pixels whose pixel position numbers along the first raster line are (1+4×n) during pass No. 1. In other words, the procedure should be performed such that the print signals PRT(i) are outputted solely when dot Nos. (1+4×n) are recorded, and no print signals PRT(i) are outputted for dot Nos. (2+4×n), (3 +4×n), or (4+4×n), irrespective of whether these dots are recorded.

The time interval spanning the formation of dots for two pixels adjacent to each other in the direction of main scan may, for example, be 20 seconds between the first pixel (whose raster number is 1 and whose pixel position number is 1 in accordance with the first embodiment) and the second pixel (whose raster number is 1 and whose pixel position number is 2), assuming that the time needed for each pass is 5 seconds. Thus, a single raster line is formed in a plurality of passes if the number of scan cycles s is 2 or greater, so the pixels adjacent to each other in the direction of main scan can be provided with dots during nonconsecutive main scans rather than during consecutive main scans. As a result, the ink drop of the dot formed in advance on a pixel adjacent in the direction of main scan will have sufficient time to dry, and the coalescence of ink drops in the direction of main scan can be reduced.

For the pixel position whose pixel position number is 1, pass No. 1 is responsible for the pixel whose raster number is 5, pass No. 2 is responsible for the pixel whose raster number is 4, pass No. 3 is responsible for the pixel whose raster number is 3, and pass No. 4 is responsible for the pixel whose raster number is 2. Consecutive passes (Nos. 1, 2, 3,) thus lie adjacent to each other in sequence. The same applies to other pixel positions.

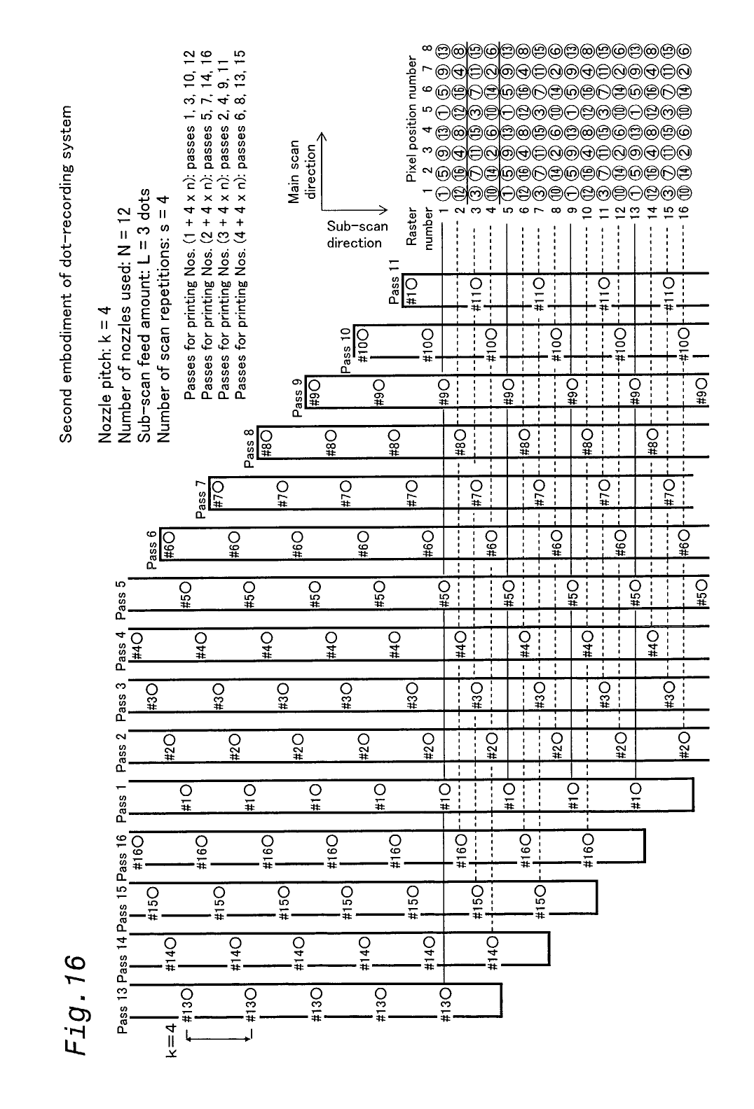

FIG. 16 is a diagram illustrating a second embodiment of the dot-recording system according to the present invention. This dot-recording system has the same parameters as the recording system of the first embodiment and is different from the recording system of the first embodiment in terms of the pixel positions recorded during each pass. Specifically, the same arrangement as in the first embodiment applies to raster line Nos. (1+4×m) and (3+4×m), but the pixel positions are different for raster line Nos. (2+4×m) and (4+4×m) adjacent thereto. In the second embodiment, the dot with a pixel position number of (1+4×n) is formed during pass No. 10, the dot with a pixel position number of (2+4×n) is formed during pass No. 14, the dot with a pixel position number of (3+4×n) is formed during pass No. 2, and the dot with a pixel position number of (4+4×n) is formed during pass No. 6. This embodiment is therefore different from the first embodiment in that dots are formed during different passes.

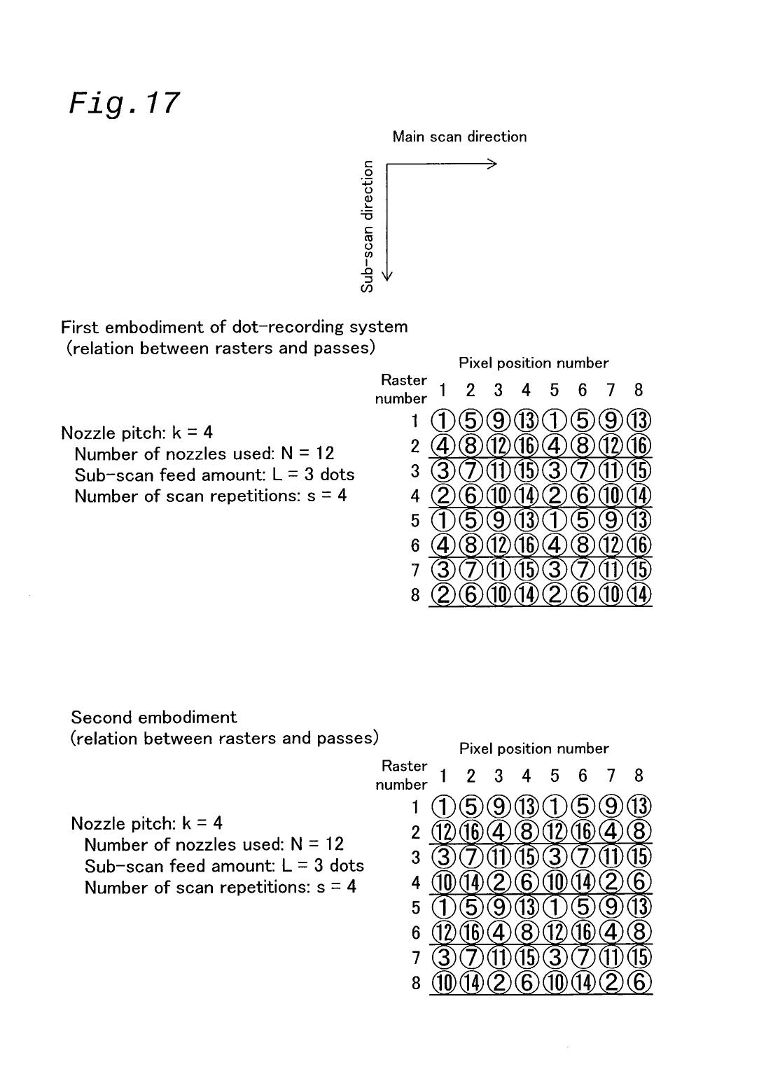

FIG. 17 is a diagram illustrating the dot-recording positions of each pass in the first and second embodiments of the dot-recording system according to the present invention. Raster line No. (4+4×m) of the second embodiment and raster line No. (4+4×m) of the first embodiment are obtained by substituting the pixel position numbers of the pixels recorded during pass Nos. 2, 6, 10, and 14, as can be seen in the drawings. Specifically, dot Nos. (1+4×n) and (2+4×n) are switched for the dots whose pixel position numbers are (3+4×n) and (4+4×n). This switch can be performed by modifying the timing of the print signal PRT(i).

A situation in which dots in the pixels adjacent in the direction of sub-scan are recorded during consecutive passes can thus be prevented by adopting an arrangement in which the timing of drive signals is modified during each pass, and the passes responsible for recording each pixel position are also modified.

Another feature of the second embodiment is that pixels recorded during consecutive passes are present among the pixels adjacent to each other in an inclined direction intermediate between the direction of main scan and the direction of sub-scan. Specifically, this corresponds to pass Nos. 4 and 5 and to pass Nos. 8 and 9. In comparison with pixels adjacent to each other in the direction of main scan or the direction of sub-scan, pixels adjacent to each other at an incline are separated by greater distances, and are hence less likely to coalesce.

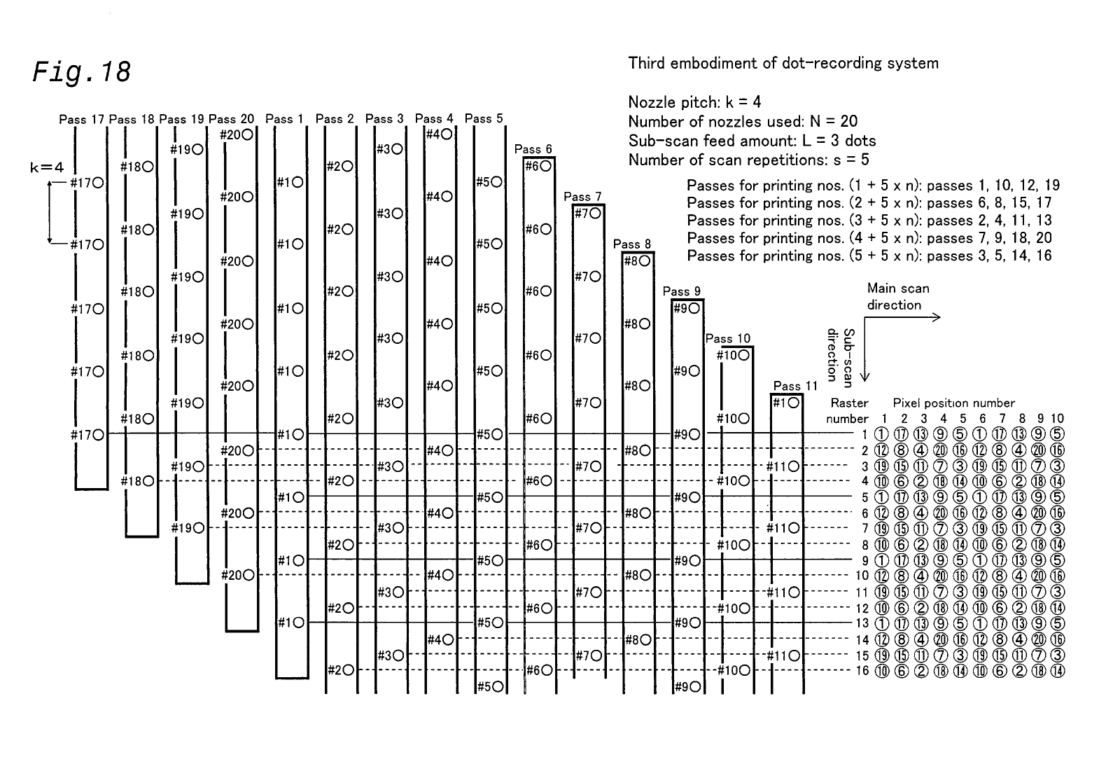

FIG. 18 is a diagram illustrating a third embodiment of the dot-recording system according to the present invention. This dot-recording system has the following parameters: N=20, k=4, L=3, and s=5. These parameters satisfy the above-described conditions c1′-c3′. It is therefore possible to perform printing without any omissions or unnecessary overlapping involving recorded dots. This embodiment is different from the second embodiment shown in FIG. 16 in that the number of scan cycles s is increased from 4 to 5 and that greater latitude is provided for the pixel positions recorded during each pass.

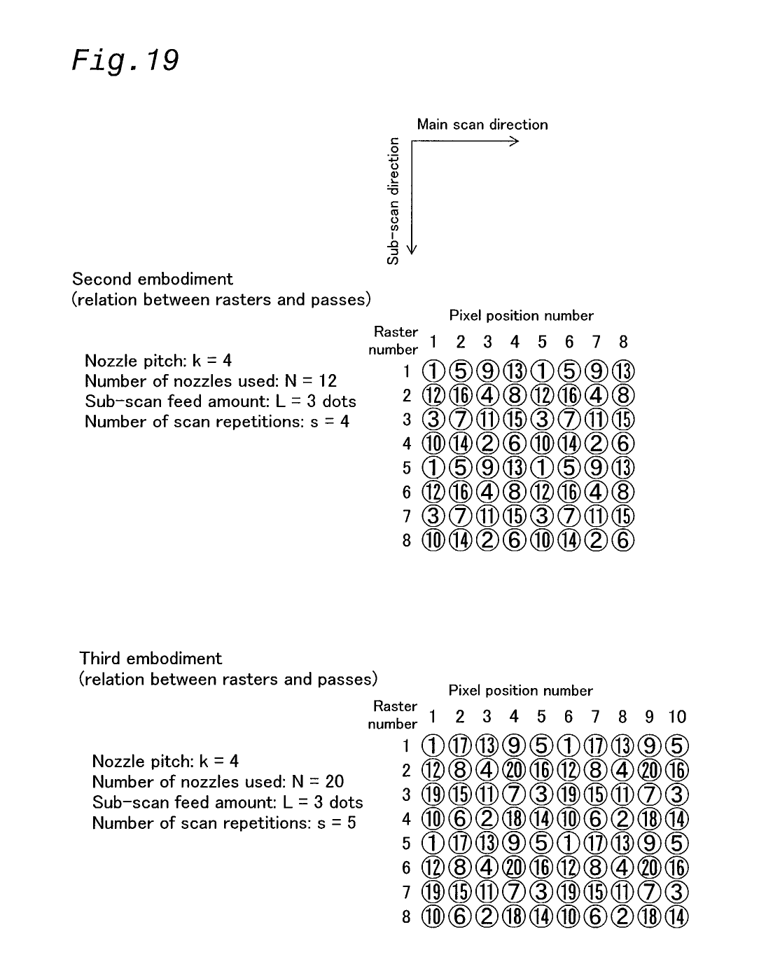

FIG. 19 is a diagram illustrating the dot-recording positions of each pass in the second and third embodiments of the dot-recording system according to the present invention. Whereas the second embodiment shown in FIG. 16 is configured such that the positions to be recorded during each pass can be selected from four pixel positions, the third embodiment is configured such that the positions to be recorded during each pass can be selected from five pixel positions whose pixel position numbers are (1+5×n), (2+5×n), (3+5×n), (4+5×n), and (5+5×n). As a result, the third embodiment is configured such that pixels adjacent to each other in an inclined direction can be recorded without involving consecutively recording passes.

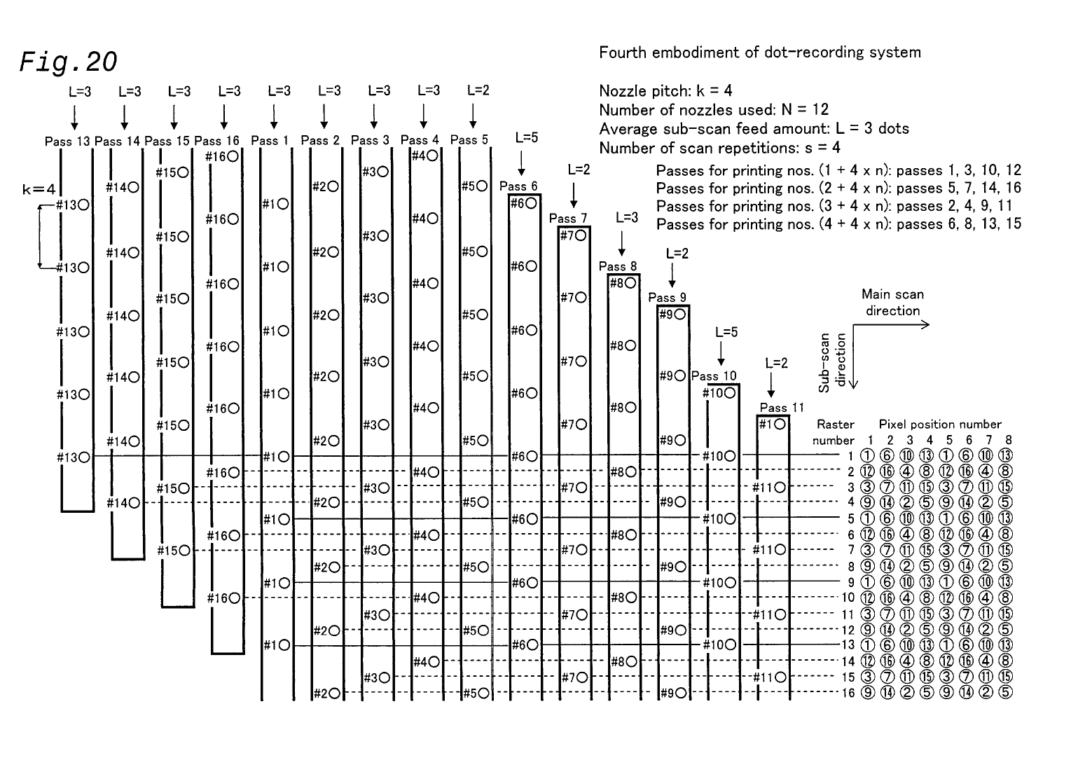

FIG. 20 is a diagram illustrating a fourth embodiment of the dot-recording system according to the present invention. This embodiment is different from the second embodiment shown in FIG. 16 in that the sub-scan feeding involves variable feeding. According to the fourth embodiment, raster lines responsible for some of the passes can be switched by modifying sub-scan feeding from constant feeding to variable feeding. Specifically, recorded dots are switched between pass Nos. 5 and 6 and pass Nos. 9 and 10.

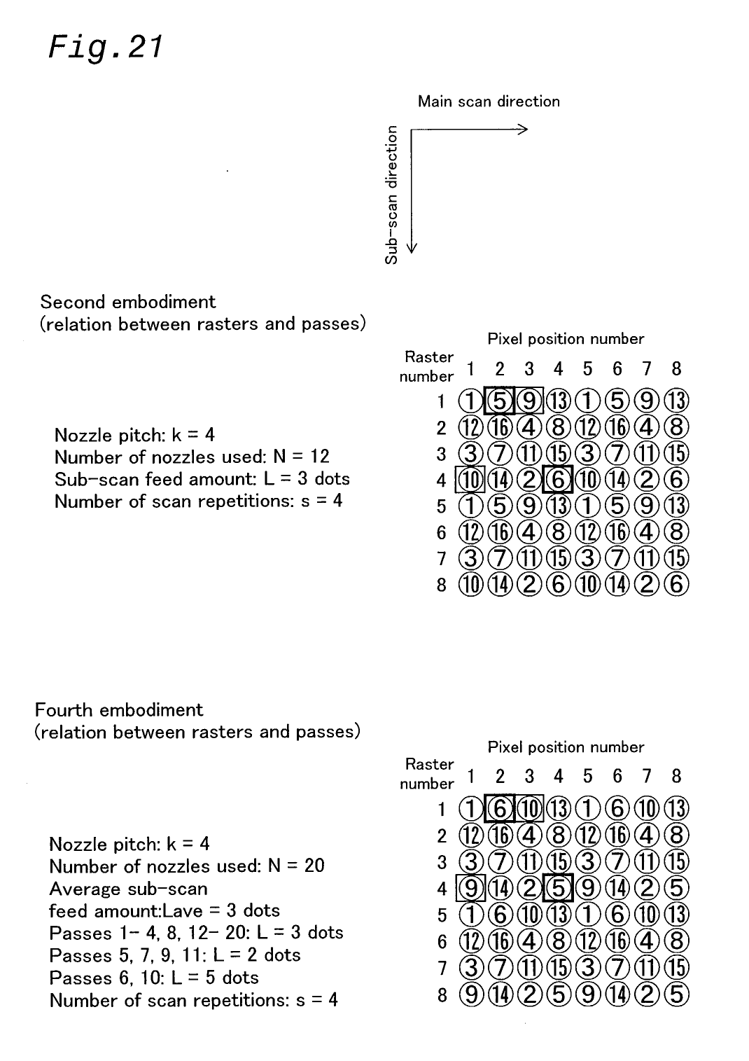

FIG. 21 is a diagram illustrating the dot-recording positions of each pass in the second and fourth embodiments of the dot-recording system according to the present invention. A comparison between the dot-recording positions of each pass in accordance with the second and fourth embodiments indicates that pass No. 5 is responsible for recording raster line No. (1+4×m) in the second embodiment, and raster line No. (4+4×m) in the fourth embodiment. Also, pass No. 6 is responsible for recording raster line No. (4+4×m) in the second embodiment, and raster line No. (1+4×m) in the fourth embodiment. Pass Nos. 9 and 10 are switched in the same manner.

The switch between the raster lines for recording data during passes can be accomplished by partially modifying the sub-scan feed amount L of each pass. Specifically, the switch between pass Nos. 5 and 6 in the fourth embodiment can be achieved by modifying the feed amount L, which is equal to 3 in the second embodiment, such that pass No. 5 is advanced at a sub-scan feed amount L of 2, pass No. 6 is advanced at a sub-scan feed amount L of 5, and pass No. 7 is advanced at a sub-scan feed amount L of 2, as shown in FIG. 20. The switch between pass Nos. 9 and 10 can be achieved by adjusting the sub-scan feed amounts in the same manner.

It can be seen from the above-described first to fourth embodiments of dot-recording systems that the pixels in which data are recorded during each pass can be modified by adjusting the timing of the drive signals for each pass or the sub-scan feed amount of each pass. It is thus possible to shift the timing for recording adjacent pixels by adequately modifying the pixels in which data are recorded during each pass, making it possible to prevent coalescence and to reduce the quality degradation of printed images.

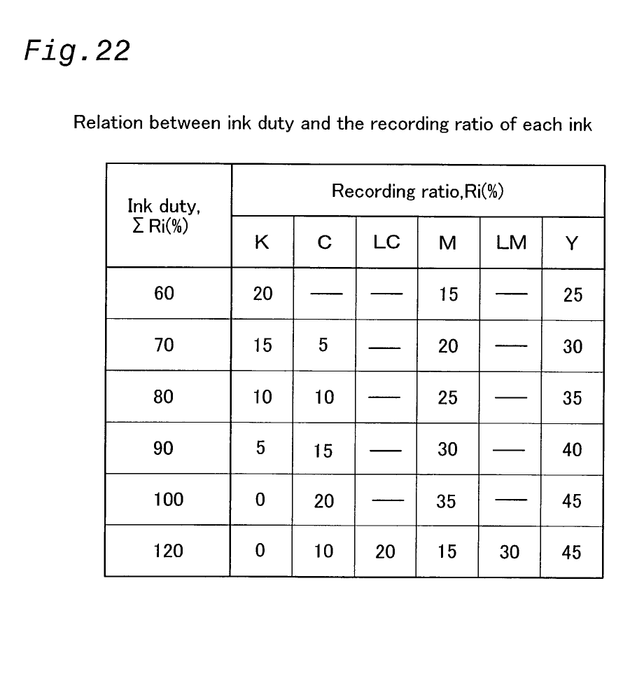

FIG. 22 is a diagram depicting the relation between ink duty and the recording rate of each ink observed when a single color is reproduced using an ideal ink. As described above, “ink duty” is a value that indicates the total amount of ink per unit surface area and that is obtained by combining the recording rates of all the inks. In the embodiment shown in FIG. 22, the combined ink duty is 100%, of which the recording rate of cyan (C) is 20%, the recording rate of magenta is 35%, the recording rate of yellow (Y) is 45%, and the recording rate of other colors is 0%.

With an ideal ink, a color reproduced using cyan at 10% recording rate, magenta at 10% recording rate, and yellow at 10% recording rate is the same as a monochromatic black color with a recording rate of 10%. Consequently, the same color can be reproduced when the recording rates of cyan, magenta, and yellow are each reduced by 5%, and the recording rate of the monochromatic black is increased by 5%. For this reason, there is no difference for an ideal ink between the color with an ink duty of 60% and the color with an ink duty of 100% in FIG. 22.

Thus, the combined recording rates of a plurality of ink colors needed to reproduce the same color vary with ink duty. It is also known that the recording rate (that is, amount of ink per unit surface area) of black ink should be increased in order to reduce ink duty. In practice, increasing the recording rate of black ink increases the graininess of black-ink dots, causes the texture of the print medium to stand out, and aggravates other problems, so the recording rate of black ink should be set by taking into account the tradeoffs between these problems and the maximum value allowed for the ink duty of the print medium.

It was thus learned that because the combined recording rates of a plurality of ink colors needed to reproduce the same color varies with ink duty, the color conversion tables LUT (see FIG. 2) used by the printer driver 96 should preferably be varied in accordance with the maximum allowable value of the ink duty. A color conversion table LUT compatible with a print medium characterized by low ink absorption should preferably be used in order to print high-quality images on such a print medium. Specifically, the color conversion table LUT for a data-recording medium should be automatically selected when the data-recording medium as selected as this print medium.

Low-density inks such as light cyan inks (FIG. 22) are often used in order to increase the number of gradations, but the use of low-density inks results in greater ink duty. It can therefore be concluded with respect to hues for which a plurality of inks having the same hue can be used that ink coalescence can be reduced by adopting an approach in which print data are created such that only inks of comparatively high density are selected from among the plurality of inks having the same hue, and that inks of maximum density are dispensed with. Specifically, the color conversion tables LUT for a data-recording medium should be compiled based on the use of dense inks alone (without any regard to the maximum allowable value of ink duty) in order to create such print data.

As described above, using a color conversion table LUT suitable for a data-recording medium makes it possible to reduce ink duty, to prevent ink coalescence, and to reduce the quality degradation of printed images.

G. Modifications

The present invention is not limited by the above-described embodiments or embodiments and can be implemented in a variety of ways as long as the essence thereof is not compromised. For example, the following modifications are possible.

G-1. The above embodiments were described with reference to cases in which circular optical disks were used for the data-recording medium, but rectangular data-recording media may also be used, for example. In such cases, the recording medium can be selected by means of the user interface 102 of the printer driver 96 or graphics software for image adjustment. Selecting the medium with the aid of graphics software has the advantage of making it possible to change the display of the image adjustment area in a manner consistent with the shape of the data-recording medium.

G-2. The above embodiments were described with reference to cases in which a resolution of 1440×720 and unidirectional printing were used for the print mode of an optical disk. It is also possible, however, to use a print mode with the lowest printing speed and to adapt this print mode to an optical disk by reducing the speed of main scan or the speed of sub-scan feeding in cases in which, for example, printing is performed in two directions or a lower resolution (720×720) is used.

G-3. The present invention can be used not only for color printing but also for black and white printing. The present invention is also applicable to printing where each pixel is reproduced with a plurality of dots of different sizes. The present invention is farther applicable to drum type printers. With a drum type printer, the drum rotation direction is the main scanning direction, and the carriage scan direction is the sub-scanning direction. Also, the present invention can be used not only for inkjet printers, but in general for dot recording apparatuses that record on the surface of a printing medium using a recording head that has multiple nozzle rows.

For the aforementioned embodiments, it is acceptable to replace part of the structure that is realized using hardware with software, and conversely, to replace part of the structure that is realized using software with hardware. For example, part or all of the functions of printer driver 96 shown in FIG. 1 can be executed by control circuit 40 within printer 20. In this case, part or all of the function of computer 90 that is the printing control apparatus that creates print data is realized by control circuit 40 of printer 20.

When realizing part or all of the functions of the present invention using software, that software (computer program) can be provided in a form stored on a computer-readable storage medium. For the present invention, “a computer-readable storage” is not limited to a portable type recording medium such as a floppy disk or CD-ROM, but also includes internal memory devices in the computer such as various types of RAM and ROM, or external memory devices connected to a computer such as a hard disk.

### INDUSTRIAL APPLICABILITY

The present invention can be adapted to the output device of a computer.

What is claimed is:

1. A printing control apparatus for generating print data to be supplied to a print unit to form ink dots on a print medium, the print unit capable of printing on a data-recording medium using a tray mountable the data-recording medium, the printing control apparatus comprising:
a user interface configured to provide a window allowing a user to select one print medium from a plurality of previously registered print mediums, and also to receive the selection by the user; and
a print data generator configured to select one print mode from a plurality of previously set print modes in response to the selected print medium, and also to generate the print data for executing printing according to the selected print mode; wherein
the print data generator is configured to generate print data for causing the print unit to print in a predetermined printable region on the data-recording medium mounted on the tray, when the selected print medium indicates a surface layer of the data-recording medium.

2. The printing control apparatus in accordance with claim 1, wherein the print medium has a round shape with a hole at a center of the print medium; and
the printable region is a ring-shaped region around the hole.

3. The printing control apparatus in accordance with any of claims 1 to 2, wherein the plurality of previously registered print mediums include various shapes of a plurality of data-recording mediums;
the tray is capable of mounting the plurality of data-recording mediums; and
the user interface allows the user to select one print medium from the plurality of data-recording mediums.

4. The printing control apparatus in accordance with any of claims 1 to 3, wherein
the print data generator is configured to generate print data configured for the print unit to print in a highest print resolution available in the print unit when the selected print medium indicates the surface layer of the data-recording medium.

5. The printing control apparatus in accordance with any of claims 1 to 4, wherein
the print data generator is configured to generate print data configured for the print unit to print in a unidirectional printing mode for printing during only one of forward and return passes of main scan when the selected print medium indicates the surface layer of the data-recording medium.

6. The printing control apparatus in accordance with any of claims 1 to 5, wherein
the print data generator comprises a plurality of color conversion tables for converting an RGB image data indicative of tones of R, G, B to multi-tone data of multiple colors available in the print unit, and use a color conversion table achieving in a minimum ink amount of all inks per unit surface area for the conversion when the selected print medium indicates the surface layer of the data-recording medium.

7. The printing control apparatus in accordance with any of claims 1 to 6, wherein
the print unit is capable of printing using same-hue inks having a substantially same hue and mutually different in density regarding at least one hue; and
the print data generator is configured to generate print data configured for the print unit to print using a comparatively richer ink rather than an ink having a leanest density among the same-hue inks regarding the hue when the selected print medium indicates the surface layer of the data-recording medium.

8. The printing control apparatus in accordance with any of claims 1 to 7, wherein
the print data generator is configured to generate print data configured for the print unit to print at pixels next to each other in the main scan direction during nonconsecutive main scans rather than during consecutive main scans when the selected print medium indicates the surface layer of the data-recording medium.

9. The printing control apparatus in accordance with any of claims 1 to 8, wherein
the print data generator is configured to generate print data configured for the print unit to print at pixels next to each other in the sub-scan direction during nonconsecutive main scans rather than during consecutive main scans when the selected print medium indicates the surface layer of the data-recording medium.

10. The printing control apparatus in accordance with any of claims 1 to 9, wherein
the print data generator is configured to generate print data configured for the print unit to print at pixels next to each other in the inclined direction during nonconsecutive main scans rather than during consecutive main scans, the inclined direction being between directions of main scan and sub-scan when the selected print medium indicates the surface layer of the data-recording medium.

11. The printing control apparatus in accordance with any of claims 1 to 10, wherein
the print data generator is configured to automatically set a specific print mode with a lowest printing speed per unit surface area at least as a default setting when the selected print medium indicates the surface layer of the data-recording medium.

12. The printing apparatus for printing using a print unit for forming ink dots on a print medium, comprising:
the print unit; and
the printing control apparatus in accordance with any of claims 1 to 11.

13. The printing apparatus in accordance with claim 12, wherein
the print unit comprise a sensor configured to sense the tray fed into the print unit;
the tray has a sensed element configured for sensed by the sensor; and
the printing apparatus controls the printable region in response to the sense of the sensed element by the sensor.

14. A printing control method for generating print data to be supplied to a print unit to form ink dots on a print medium, the print unit capable of printing on a data-recording medium using a tray mountable the data-recording medium, the printing control apparatus comprising:
(a) providing a window allowing a user to select one print medium from a plurality of previously registered print mediums, and also to receive the selection by the user; and
(b) selecting one print mode from a plurality of previously set print modes in response to the selected print medium, and also generating the print data for executing printing according to the selected print mode; wherein
the step (b) includes the step of generating print data configured for the print unit to print in a predetermined printable region on the data-recording medium mounted on the tray, when the selected print medium indicates a surface layer of the data-recording medium.

15. A computer program for generating print data to be supplied to a print unit to form ink dots on a data-recording medium using a tray mountable the data-recording medium, the computer program comprising programs for causing a computer to perform:
an interface function for providing a window allowing a user to select one print medium from a plurality of previously registered print mediums, and also to receive the selection by the user; and
a print data generation function for selecting one print mode from a plurality of previously set print modes in response to the selected print medium, and also generating the print data for executing printing according to the selected print mode; wherein
the print data generation function includes a function of generating print data configured for the print unit to print in a predetermined printable region on the data-recording medium mounted on the tray, when the selected print medium indicates a surface layer of the data-recording medium.

16. A computer-readable recording medium, storing the computer program in accordance with claim 15.
